(19) United States
(12) Patent Application Publication
(10) Pub. No.: US 2010/0000234 A1
(43) Pub. Date: Jan. 7, 2010

(54) METHOD AND APPARATUS FOR THE VAPORIZATION OF A LIQUID HYDROCARBON STREAM

(76) Inventors: Eduard Coenraad Bras, The Hague (NL); Jill Hui Chiun Chieng, The Hague (NL); Akash Damodar Wani, The Hague (NL)

Correspondence Address: SHELL OIL COMPANY, P O BOX 2463, HOUSTON, TX, 772522463, US

(21) Appl. No.: 12/438,147

(22) PCT Filed: Aug. 21, 2007
(86) PCT No.: PCT/EP07/58650

§ 371 Date: Feb. 20, 2009

(30) Foreign Application Priority Data
Aug. 23, 2006 (EP) 06119356.1

(51) Int. Cl. F17C 7/04; F25J 1/00; F17C 9/04

(52) U.S. Cl. 62/50.5; 62/614; 62/50.2

(57) ABSTRACT

The present invention relates to a method for the vaporization of a liquid hydrocarbon stream (110) such as LNG, the method at least comprising the steps of: (a) supplying a partly condensed hydrocarbon feed stream (10) to a first gas/liquid separator (2); (b) separating the hydrocarbon feed stream (10) in the first gas/liquid separator (2) into a gaseous stream (20) and a liquid stream (30); (c) expanding the liquid stream (30) and feeding it (40) into a second gas/liquid separator (3); (d) expanding the gaseous stream (20) and feeding it into the second gas/liquid separator (3); (e) removing from the second gas/liquid separator (3) a gaseous stream (60) and feeding it (70) into a third gas/liquid separator (4); (f) separating the stream (70) thereby obtaining a liquid stream (80) and a gaseous stream (90); (g) feeding the liquid stream (80) into the second gas/liquid separator (3); and (h) removing from the second gas/liquid separator (3) a liquid stream (100, 100a); wherein the gaseous stream (60) is partially condensed by heat exchanging against a liquid hydrocarbon stream (110) to be vaporized.

The present invention relates to a method and apparatus for the vaporization of a liquid hydrocarbon stream such as a liquefied natural gas (LNG) stream.

Several processes and apparatuses for the vaporization of LNG are known, and may involve recovery of the cold in the LNG.

EP 1 469 265 describes a process for nitrogen liquefaction by recovering the cold derived from liquid methane gasification.

GB 1 008 394 discloses the recuperation of caloric potential of liquefied gas during regasification. According to GB 1 008 394 methane is separated from ethane and heavier constituents during regasification of the LNG. The ethane and heavier constituents are converted into ethylene. The caloric potential of refrigeration value during revaporization of the LNG provides the refrigeration duty for the separation of the ethane and heavier constituents from the methane contained in the LNG and for the separation and purification of ethylene.

In the method disclosed in GB 1 008 394 is that the cold in the liquid hydrocarbon stream is not recovered in a sufficient extent. As an ethylene plant must be operated at a relatively uniform rate, GB 1 008 394 contemplates (see column 2, lines 10-22) to use only that part of the refrigeration potential resulting from the guaranteed minimum daily gas delivery volume.

Further, according to GB 1 008 394 it is desirable to not completely vaporize the LNG against streams in the plant since complete vaporization of the LNG would make the separation of methane from ethane and heavier constituents more difficult (see e.g. column 4, lines 58-65 of GB 1 008 394).

Moreover, the known method is rather complicated thereby resulting in high capital expenses (CAPEX).

It is an object of the present invention to minimize one or more of the above problems, while at the same time maintaining or even improving the recovery of cold during vaporization of a liquid hydrocarbon stream, in particular LNG.

The present invention provides a method for the vaporization of a liquid hydrocarbon stream such as liquefied natural gas, the method at least comprising the steps of:

(a) supplying a partly condensed hydrocarbon feed stream to a first gas/liquid separator;

(b) separating the hydrocarbon feed stream in the first gas/liquid separator into a gaseous stream and a liquid stream;

(c) expanding the liquid stream obtained in step (b) and feeding it into a second gas/liquid separator at a first feeding point;

(d) expanding the gaseous stream obtained in step (b), thereby obtaining an at least partially condensed stream, and subsequently feeding it into the second gas/liquid separator at a second feeding point;

(e) removing from the second gas/liquid separator a gaseous stream, partially condensing it and feeding it into a third gas/liquid separator;

(f) separating the stream fed in the third gas/liquid separator in step (e) thereby obtaining a liquid stream and a gaseous stream;

(g) feeding the liquid stream obtained in step (f) into the second gas/liquid separator at a third feeding point; and

(h) removing from the second gas/liquid separator a liquid stream;

wherein the gaseous stream removed from the second gas/liquid separator in step (e) is partially condensed by heat exchanging against a liquid hydrocarbon stream to be vaporized.

The method may include at least partially vaporizing the liquid hydrocarbon stream, wherein at least partially vaporizing the liquid hydrocarbon stream comprises said heat exchanging against the gaseous stream removed from the second gas/liquid separator in step (e). Notwithstanding, the liquid hydrocarbon stream to be vaporized may still contain liquid, or be in dense phase, after the heat exchanging against the gaseous stream from the second gas/liquid separator.

If necessary, the hydrocarbon stream to be vaporized may have to be further heated in order to be further vaporized, after said heat exchanging against the gaseous stream removed from the second gas/liquid separator.

The method may thus comprise further steps involving vaporizing of the liquid hydrocarbon stream during or after the heat exchanging against the gaseous stream removed from the second gas/liquid separator.

In a further aspect the present invention provides an apparatus for the vaporization of a liquid hydrocarbon stream such as a liquefied natural gas stream, the apparatus at least comprising:

a first heat exchanger arranged to receive a liquid hydrocarbon stream to be vaporized and to

a first gas/liquid separator having an inlet for a partly condensed hydrocarbon feed stream, a first outlet for a gaseous stream and a second outlet for a liquid stream;

a second gas/liquid separator having at least a first outlet for a gaseous stream and a second outlet for a liquid stream and first, second and third feeding points;

a third gas/liquid separator having an inlet for the stream obtained at the first outlet of the second gas/liquid separator, a first outlet for a gaseous stream and a second outlet for a liquid stream, the second outlet being connected to the third feeding point of the second gas/liquid separator;

a first expander for expanding the gaseous stream obtained from the first outlet of the first gas/liquid separator;

a second expander for expanding the liquid stream obtained from the second outlet of the first gas/liquid separator;

a first heat exchanger between the first outlet of the second gas/liquid separator and the inlet of the third gas/liquid separator; and

wherein in the first heat exchanger is arranged to receive the liquid hydrocarbon stream to be vaporized and to receive heat from the gaseous stream obtained from the first outlet of the second gas/liquid separator.

In still a further aspect, the invention provides an apparatus for the vaporization of a liquid hydrocarbon stream such as a liquefied natural gas stream, the apparatus at least comprising:

a first gas/liquid separator having an inlet for a partly condensed hydrocarbon feed stream, a first outlet for a gaseous stream and a second outlet for a liquid stream;

a second gas/liquid separator having at least a first outlet for a gaseous stream and a second outlet for a liquid stream and first, second and third feeding points;

a third gas/liquid separator having an inlet for the stream obtained at the first outlet of the second gas/liquid separator, a first outlet for a gaseous stream and a second outlet for a liquid stream, the second outlet being connected to the third feeding point of the second gas/liquid separator;

a first expander connected to the first outlet of the first gas/liquid separator and comprising a first expander outlet) connected to the second feeding point of the second gas/liquid separator;

a second expander connected to the second outlet of the first gas/liquid separator and comprising a second expander outlet connected to the first feeding point of the second gas/liquid separator;

a first heat exchanger between the first outlet of the second gas/liquid separator and the inlet of the third gas/liquid separator; and

wherein in the first heat exchanger is arranged to receive the liquid hydrocarbon stream to be vaporized and to receive heat from the gaseous stream obtained from the first outlet of the second gas/liquid separator.

These apparatuses may be suitable for performing the method provided by the present invention.

The invention will be further illustrated hereinafter, by way of example, and with reference to the following non-limiting drawing. In the drawing shows:

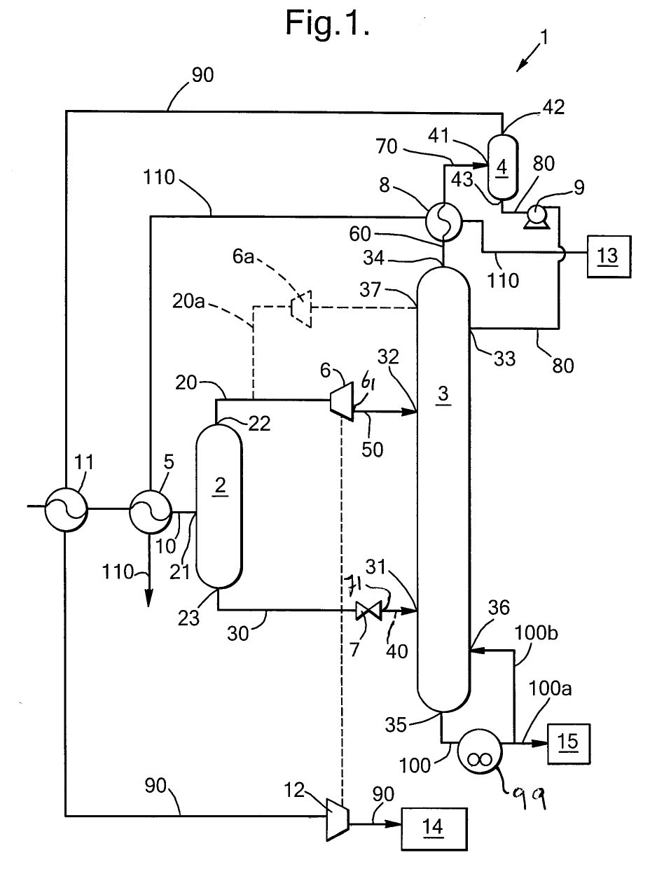

FIG. 1 schematically a process scheme in accordance with the present invention;

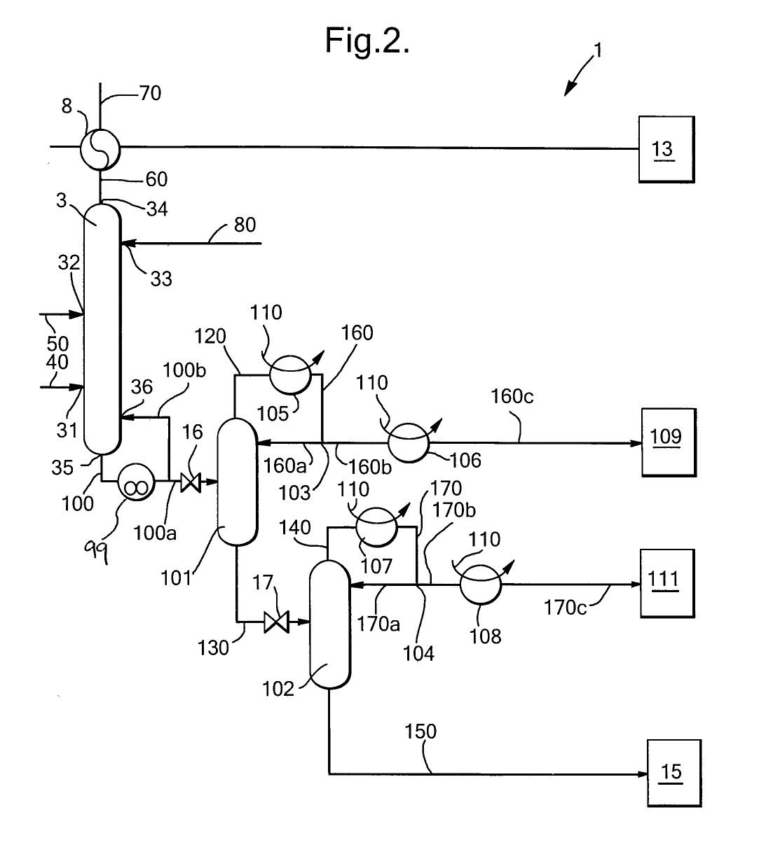

FIG. 2 schematically a part of an alternative process scheme in accordance with the present invention; and

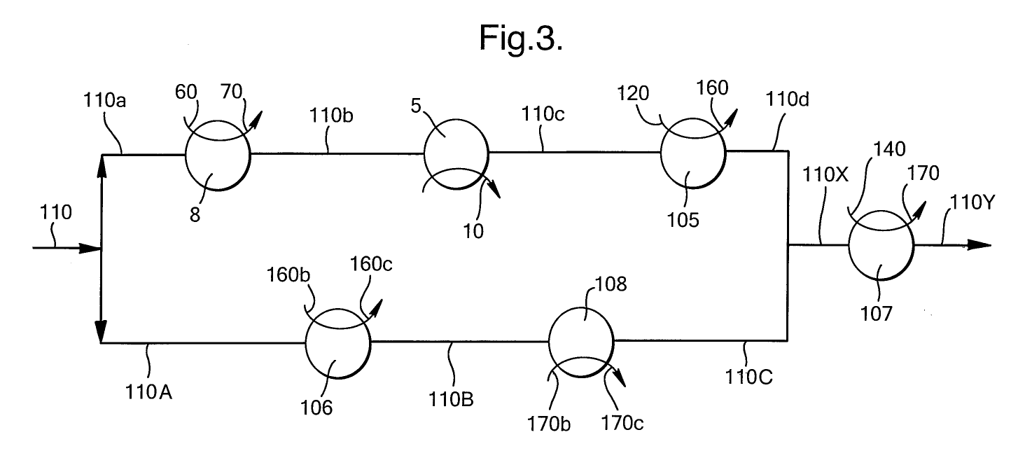

FIG. 3 schematically a preferred flow scheme of the LNG stream as used in FIG. 2.

For the purpose of this description, a single reference number will be assigned to a line as well as a stream carried in that line. Same reference numbers refer to similar components.

The present invention relates to the vaporization of a liquid hydrocarbon stream. Various embodiments described hereinbelow involve recovery of at least some of the cold in the liquid hydrocarbon stream. Part of the cold in the liquid hydrocarbon stream to be vaporized may be recovered, by using the cold in a process for recovering certain selected constituents from a hydrocarbon feed stream, e.g. by indirect heat exchange against the hydrocarbon feed stream or parts thereof. A surprisingly adequate way of doing this is to partially condense an overhead gas stream from a liquid/gas separator such as a distillation column e.g. to produce a reflux liquid.

Various embodiments of the present invention may thus provide an alternative method for the vaporization of a liquid hydrocarbon stream by indirect heat exchange against a separate hydrocarbon feed stream thereby recovering one or more of ethane, propane, butanes and higher hydrocarbons such as pentane from the separate hydrocarbon feed stream.

It has been found that using the surprisingly simple method as proposed herein, the CAPEX can be significantly lowered, whilst full advantage is taken of the cold available in the liquid hydrocarbon stream to be vaporized. Further, also due to its simplicity, the method provided by the present invention and apparatuses for performing the method have proven very robust when compared with known line-ups.

An important advantage of the present method and apparatus is that the amount of heating by “conventional” vaporizers, such as air or water coolers, to fully vaporize the liquid hydrocarbon stream can be minimized. In some embodiments according to the present invention, no heating by air or water coolers (without cold recovery) may be necessary at all, as in that case all heating necessary for the vaporization of the liquid hydrocarbon stream to be vaporized is performed by indirect heat exchange against one or more separate hydrocarbon streams.

It is known in the art of vaporizing cold hydrocarbon streams, such as LNG, that there exists a liquid phase and a so-called dense phase wherein the hydrocarbon stream is super critical whereby separate gas and liquid phases do not exist. In the dense phase, the hydrocarbon stream is neither a gas nor a liquid. However, for the purpose of this disclosure, the term “liquid hydrocarbon stream” is intended to cover non-vaporous phases including both cases wherein the hydrocarbon stream is in the liquid phase as well as where it is in the dense phase.

It is an object of various embodiments of the invention to provide a method for the vaporization of a liquid hydrocarbon stream by indirect heat exchange against a separate hydrocarbon feed stream, wherein the liquid hydrocarbon stream to be vaporized has a relatively high pressure, such as above 70 bar, and is in the dense phase.

The method provided by the present invention is also expected to be suitable for liquid hydrocarbon streams to be vaporized having a pressure above 70 bar and/or being in the dense phase. In this respect it is noted that according to GB 1 008 394 vaporization of LNG is (partly) performed, whilst the LNG has a pressure between 150 to 300 psig, thus not higher than about 20 bar.

At the same time of vaporization of the liquid hydrocarbon stream to be vaporized, the recovery of one or more of ethane, propane, butanes and higher hydrocarbons such as pentane from a hydrocarbon feed stream is provided, by indirect heat exchange against the hydrocarbon feed stream.

The recovery of one or more of ethane, propane, butanes and higher hydrocarbons may involve supplying the hydrocarbon feed stream or parts thereof to first, second, and third gas/liquid separators.

The hydrocarbon feed stream is preferably a separate stream i.e. not originating from the liquid hydrocarbon stream to be vaporized. The recovery of hydrocarbons may be done for several purposes. One purpose may be the production of hydrocarbon streams consisting primarily of hydrocarbons heavier than methane such as natural gas liquids (NGLs; usually composed of ethane, propane and butanes), liquefied petroleum gas (LPG; usually composed of propane and butane) or condensates (usually composed of butanes and heavier hydrocarbon components). Another purpose may be the adjustment of e.g. the heating value of the hydrocarbon feed stream to correspond to desired gas network specifications.

Another advantage of the methods herein described is that they are suitable for a broad range of hydrocarbon feed stream compositions.

In the context of the present specification and disclosure, vaporization means that the liquid hydrocarbon stream (usually having a temperature of below about −150° C. before vaporization) to be vaporized is heated to a temperature of about 10° C. or higher, preferably to about 16° C. or higher. The person skilled in the art understands that at the temperature of about 10° C. or higher, or of about 16° C. or higher, the “vaporized liquid hydrocarbon stream” is not necessarily fully in the vapour state yet, e.g. when the stream is in the dense phase.

Preferably, all heating necessary for the vaporization of the liquid hydrocarbon stream to be vaporized is performed by indirect heat exchange against separate hydrocarbon streams. However, although less preferred, some heating by e.g. air or water coolers (without cold recovery) may be used. Before sending the vaporized liquid hydrocarbon stream to the end user, e.g. by means of a gas network, some further processing steps may be performed such as adjustment of heating value, pressure, temperature and the like.

The liquid hydrocarbon stream to be vaporized may be any hydrocarbon-containing stream, suitably an LNG stream. Preferably the liquid hydrocarbon stream is a cold stream obtained from a source of LNG, preferably from an LNG storage tank or an LNG off-loading line at an LNG import terminal. As is customary to the person skilled in the art, the LNG stream may have various compositions. Often, the LNG stream to be vaporized is comprised substantially of methane. The LNG may contain varying amounts of hydrocarbons heavier than methane such as ethane, propane, butanes and pentanes.

The hydrocarbon feed stream may be any suitable hydrocarbon-containing gas stream to be treated, suitably a natural gas stream obtained from natural gas or petroleum reservoirs. As an alternative, the natural gas stream or the hydrocarbon-containing gas stream may also be obtained from another source, also including a synthetic source such as a Fischer-Tropsch process. As mentioned above, the hydrocarbon feed stream is preferably a separate stream (i.e. not originating from the liquid hydrocarbon stream to be vaporized).

Often the hydrocarbon feed stream is comprised substantially of methane. Depending on the source, the hydrocarbon feed stream may contain varying amounts of hydrocarbons heavier than methane such as ethane, propane, butanes and pentanes as well as some aromatic hydrocarbons. The hydrocarbon feed stream may also contain non-hydrocarbons such as H₂O, N₂, CO₂, H₂S and other compounds, and the like.

In embodiments, the hydrocarbon feed stream is supplied to a first gas/liquid separator in a partially condensed form.

If desired, the hydrocarbon feed stream may be pre-treated before feeding it to the first gas/liquid separator. This pre-treatment may comprise removal of undesired components such as CO₂ and H₂S, or other steps such as pre-cooling, pre-pressurizing or the like. As these steps are well known to the person skilled in the art, they are not further discussed here.

The partially condensed hydrocarbon feed stream preferably has a pressure >20 bar, preferably from 30 to 100 bar.

The first, second and third gas/liquid separator may be any suitable means for obtaining a gaseous stream and a liquid stream, such as a scrubber, distillation column, etc. If desired, four or more gas/liquid separators may be present. Preferably the second gas/liquid separator is a de-methanizer or a de-ethanizer, i.e. wherein as an gaseous overhead stream respectively a methane-enriched and an ethane-enriched stream is obtained when compared with the feed stream. Most preferably the second gas/liquid separator is a de-ethanizer. Usually the pressure in the second gas/liquid separator is from 10 to 50 bar. In case the second gas/liquid separator is a de-methanizer, the pressure is preferably from 20 to 25 bar. In case the second gas/liquid separator is a de-ethanizer, the pressure is preferably from 30 to 35 bar.

Embodiments of the methods described herein may include steps of expanding a gaseous stream and/or a liquid stream. The person skilled in the art will understand that the steps of expanding may be performed in various ways using any type of expansion device (e.g. using a throttling valve, a flash valve or a common expander).

The person skilled in the art will readily understand that the various product streams obtained from the hydrocarbon feed stream may be further processed, if desired. Also, further intermediate processing steps between the first and third gas/liquid separator may be performed.

According to a preferred embodiment the present invention the method may further comprise feeding the liquid stream removed from the second gas/liquid separator to a fourth gas/liquid separator thereby obtaining a liquid stream and a gaseous stream. This may hereinafter be referred to as step (i).

Further it is preferred that the method comprises feeding the liquid stream obtained from the fourth gas/liquid separator to a fifth gas/liquid separator thereby obtaining a liquid stream and a gaseous stream, which hereinafter may be referred to as step (j).

Again, the fourth and fifth gas/liquid separator may be any suitable means for obtaining a gaseous stream and a liquid stream, such as a scrubber, distillation column, etc. Preferably the fourth gas/liquid separator is a de-ethanizer or a de-propanizer, i.e. wherein as a gaseous stream respectively an ethane-rich and a propane-rich stream is obtained. Most preferably the fourth gas/liquid separator is a de-propanizer. Preferably the fifth gas/liquid separator is a de-propanizer or a de-butanizer, i.e. wherein as a gaseous stream respectively a propane-rich and a butane-rich stream is obtained. Most preferably the fifth gas/liquid separator is a de-butanizer.

Various embodiments of the method provided by the invention are aimed at vaporization of the liquid hydrocarbon feed stream. Part of the cold in the liquid hydrocarbon feed may be recovered by using it in a process for recovering selected constituents from a hydrocarbon feed stream. At least part of the heat required for the vaporization may be drawn from the hydrocarbon feed stream or parts thereof by indirect heat exchange.

In addition to, or instead of, partially condensing the gaseous stream removed from the second gas/liquid separator by heat exchanging against the liquid hydrocarbon stream to be vaporized, the method according to the present invention may thus comprise a step (k), comprising cooling the gaseous stream obtained in step (i) by heat exchange against the liquid hydrocarbon stream to be vaporized. Herewith a cooled stream is obtained, while heat is added to the liquid hydrocarbon stream to be vaporized. In a preferred embodiment the cooled stream is split into at least two streams, a first stream being recycled to the fourth gas/liquid separator and a second stream being further cooled by heat exchange against the liquid hydrocarbon stream to be vaporized. As a result a further cooled stream is obtained, that may be in liquefied form and may be sent to a storage tank. The splitting is suitably performed in a splitter, as a result of which at least two streams having the same composition are obtained. If desired, also e.g. a gas/liquid separator may be used for the splitting, but then resulting in two or more streams that may not all have the same composition.

Similarly, and likewise in addition to or instead of partially condensing the gaseous stream removed from the second gas/liquid separator by heat exchanging against the liquid hydrocarbon stream to be vaporized, the method according to the present invention may further comprise cooling the gaseous stream obtained in step (j) by heat exchange against the liquid hydrocarbon stream to be vaporized. This may hereinafter be referred to as step (l). Again, a cooled stream is obtained herewith as heat is added to the liquid hydrocarbon stream to be vaporized. In preferred embodiments, the cooled stream is split into at least two streams: a first stream being recycled to the fifth gas/liquid separator and a second stream being further cooled by heat exchange against the liquid hydrocarbon stream to be vaporized. As a result, a further cooled stream is obtained, that may be in liquefied form and may be sent to a storage tank.

An advantage of the steps (k) and (l) described above, is that—by using the available cold of the liquid hydrocarbon stream—the fourth and fifth gas/liquid separators can be operated at lower pressure, which results in lower CAPEX.

According to an especially preferred embodiment of the method of the present invention, in addition to or instead of partially condensing the gaseous stream removed from the second gas/liquid separator by heat exchanging against the liquid hydrocarbon stream to be vaporized, the partially condensed hydrocarbon feed stream has been previously cooled against the liquid hydrocarbon stream to be vaporized before feeding it to the first gas/liquid separator. Herewith part of the heat required for vaporization may be added to the liquid hydrocarbon stream to be vaporized, thereby forming another way to recover part of the cold from the liquid hydrocarbon stream to be vaporized.

The partially condensed stream from the second gas/liquid separator, obtained after cooling the gaseous overhead stream from the second gas/liquid separator against the liquid hydrocarbon stream to be vaporized, may be separated in a third gas/liquid separator, thereby obtaining a liquid stream and a gaseous stream. This may hereinafter be referred to as step (f). In further preferred embodiments, the gaseous stream obtained in step (f) is sent to a gas network. Also, the vaporized liquid hydrocarbon stream to be vaporized may be sent to a gas network.

The liquid hydrocarbon stream to be vaporized may be in the dense phase. Preferably the pressure of the liquid hydrocarbon stream to be vaporized is at least 5 bar above the critical point until it has reached a temperature of about 16° C. Also, the liquid hydrocarbon stream to be vaporized may have a pressure of at least 70 bar, preferably above 80 bar. The pressure is further preferably below 100 bar, more preferably below 90 bar. An advantage of the use of high pressures and/or dense phase is that any problems associated with two-phase streams (such as the necessity of additional knock out vessels, pumps, etc.) may be minimized or avoided.

Preferably the liquid hydrocarbon stream to be vaporized is heat exchanged against the gaseous stream removed from the second gas/liquid separator before it is heat exchanged against one or more of the gaseous streams removed from the fourth and fifth gas/liquid separators. Herewith the cold of the liquid hydrocarbon stream to be vaporized is more efficiently recovered, because the heat exchanger network then provides the optimal temperature approach for the cold recovery during the vaporization of LNG, i.e. from about −155° C. to about 16° C.

Although the gaseous stream obtained in step (f) may be used for various purposes, it is preferably sent to a gas network. Alternatively it may e.g. be liquefied thereby obtaining a liquefied hydrocarbon stream such as liquefied natural gas (LNG).

Further, at least a part of the liquid stream removed from the bottom of the second gas/liquid separator, and, if provided the optional fourth or fifth gas/liquid separators, is preferably subjected to (further) fractionation thereby obtaining two or more fractionated streams.

FIG. 1 schematically shows a process scheme (generally indicated with reference no. 1) for the vaporization of a liquid hydrocarbon stream such as LNG by indirect heat exchange against a hydrocarbon feed stream whereby ethane and heavier hydrocarbons are recovered form the hydrocarbon feed stream to a certain extent. Preferably, the hydrocarbon feed stream is a separate stream (i.e. not originating from the LNG to be vaporized).

The process scheme of FIG. 1 comprises a first gas/liquid separator 2 having an inlet 21 for a partly condensed hydrocarbon feed stream 10, a first outlet 22 for a gaseous stream 20 and a second outlet 23 for a liquid stream 30; a second gas/liquid separator 3 (shown here in the form of a distillation column, preferably a de-ethanizer) having at least a first outlet 34 for a gaseous stream 60 and a second outlet 35 for a liquid stream 100 and first, second and third feeding points (31,32,33, respectively); a third gas/liquid separator 4; a first expander 6 for expanding the gaseous stream 20 obtained from the first outlet 22 of the first gas/liquid separator 2; a second expander 7 (here shown in the form of a throttling valve) for expanding the liquid stream 30 obtained from the second outlet 23 of the first gas/liquid separator 2; a first heat exchanger 8; a separate source 13 of the LNG to be vaporized (in the embodiment of FIG. 1 an LNG storage tank at an LNG import terminal); a gas network 14 and a fractionation unit 15. The person skilled in the art will readily understand that further elements may be present if desired.

Typically the first expander 6, which may be connected to the first outlet 22 of the first gas/liquid separator 2, comprises a first expander outlet 61 that may be connected to the second feeding point 32 of the second gas/liquid separator 3. The second expander, likewise, may typically be connected to the second outlet 23 of the first gas/liquid separator 2 and may comprise a second expander outlet 71 connected to the first feeding point 31 of the second gas/liquid separator 3.

During use, a partly condensed hydrocarbon feed stream 10 containing natural gas is supplied to the inlet 21 of the first gas/liquid separator 2 at a certain inlet pressure and inlet temperature. Typically, the inlet pressure to the first gas/liquid separator 2 will be between 10 and 100 bar, preferably above 30 bar and preferably below 90 bar, more preferably below 70 bar. The temperature will usually between 0 and −60° C. To obtain the partly condensed hydrocarbon feed stream 10, it may have been pre-cooled in several ways. In the embodiment of FIG. 1, the feed steam has been heat exchanged in heat exchanger 11 against stream 90 (to be discussed hereafter) and subsequently in heat exchanger 5 against stream 110 originating from the LNG storage tank 13. It goes without saying that instead of stream 110 a common external refrigerant such as propane or an other cooler such as an air or water cooler may be used.

If desired the hydrocarbon feed stream 10 may have been further pre-treated before it is fed to the first gas/liquid separator 2. As an example, CO₂, H₂S and hydrocarbon components having the molecular weight of pentane or higher may also at least partially have been removed from the hydrocarbon feed stream 10 before entering the first separator 2. In this respect it is noted that the apparatus 1 according to the present invention—in case the second gas/liquid separator 3 is a de-ethanizer—has a high tolerance to CO₂, as a result of which it is not necessary to remove the CO₂ if no liquefaction of the (overhead) product streams obtained from the hydrocarbon feed steam 10 takes place after the treating in apparatus 1.

In the first gas/liquid separator 2, the hydrocarbon feed stream 10 (fed at inlet 21) is separated into a gaseous overhead stream 20 (removed at first outlet 22) and a liquid bottom stream 30 (removed at second outlet 23). The overhead stream 20 is enriched in methane (and usually also ethane) relative to the hydrocarbon feed stream 10.

The bottom stream 30 is generally liquid and usually contains some components that are freezable when they would be brought to a temperature at which methane is liquefied. The bottom stream 30 may also contain hydrocarbons that can be separately processed to form liquefied petroleum gas (LPG) products. The stream 30 is expanded in the second expander 7 to the operating pressure of the distillation column 3 (usually about 35 bar) and fed into the same at the first feeding point 31 as stream 40. If desired a further heat exchanger (not shown) may be present on line 40 to heat the stream 40. The second expander 7 may be any expansion device such as a common expander as well as a flash valve.

The gaseous overhead stream 20 removed at the first outlet 22 of the first separator 2 is at least partially condensed in the first expander 6 and subsequently fed as stream 50 into the distillation column 3 at a second feeding point 32, the second feeding point 32 being at a higher level than the first feeding point 31. If desired a further heat exchanging step may take place between the first expander 6 and the second feeding point 32.

If desired (and as indicated with dashed lines in FIG. 1) the gaseous overhead stream 20 may be split into two streams; the ‘additional’ stream 20a may be expanded in expander 6a and fed into the distillation column 3 at a further feeding point 37.

Preferably, the pressure in the distillation column 3 is from 10 to 50 bar, preferably from 30 to 40 bar, more preferably about 35 bar.

From the top of the distillation column 3, at first outlet 34, a gaseous overhead stream 60 is removed that can be cooled, in the first heat exchanger 8, against a liquid hydrocarbon stream that is to be vaporized. In the present embodiment, the gaseous overhead stream 60 is partially condensed in first heat exchanger 8 while heat exchanging it against the cold LNG stream 110 (originating from LNG storage tank 13), and is fed into third gas/liquid separator 4 (at inlet 41) as stream 70.

The stream 70 being fed into the third gas/liquid separator 4 at inlet 41 is separated thereby obtaining a gaseous stream 90 (at outlet 42) and a liquid stream 80 (at outlet 43).

The liquid stream 80 removed at outlet 43 is pumped via pump 9 and fed into the distillation column 3 at a third feeding point 33, the third feeding point 33 being at a higher level than the second feeding point 32. Preferably the third feeding point 33 is at the top of the distillation column 3.

The gaseous stream 90 obtained at the outlet 42 of the third gas/liquid separator 4 is forwarded to the gas network 14 after heat exchanging against the hydrocarbon feed stream 10 in heat exchanger 11 and optionally compressing in compressor 12 (which is functionally coupled to first expander 6).

Usually, a liquid bottom stream 100 is removed from the second outlet 35 of the distillation column 3 and is subjected to one or more fractionation steps in a fractionation unit 15 to collect various natural gas liquid products (as shown in FIG. 2 hereafter). As the person skilled in the art knows how to perform fractionation steps, this is not further discussed here.

If desired, and as shown in FIG. 1, a part of the liquid bottom stream 100 may be returned to the bottom of the distillation column 3 as stream 100b, the remainder of stream 100 being indicated with stream 100a. Optional cooling against ambient air or water may be applied to stream 100 and/or stream 100b, e.g. using optional cooler 99 as shown in FIG. 1.

By the indirect heat exchange of the LNG stream 110 against the various streams originating from the separate hydrocarbon feed stream 10, the LNG has been heated and may be at least partly vaporized. As it is intended according to the present invention to heat the LNG to a temperature of above 10° C., preferably above about 16° C., if desired, some further heating may be performed by the use of air or water coolers or other external streams, without recovering the cold. However, preferably some more cold will be recovered by indirect heat exchange, as discussed in FIG. 2.

The heated LNG stream 110 (or 110Y in FIG. 3) will usually also be sent to a gas network. If desired some further processing steps may be performed such as adjustment of heating value, pressure, temperature, etc.

FIG. 2 shows a part of an alternative embodiment to FIG. 1, wherein the bottom stream 100,100a from the distillation column 3 (preferably a de-ethanizer thereby obtaining an ethane-enriched overhead stream 60 when compared to the feed stream 10) in FIG. 1 is further treated in a fourth gas/liquid separator 101 (preferably a de-propanizer) and fifth gas/liquid separator 102 (preferably a de-butanizer). Further, FIG. 2 shows stream splitters 103 and 104, heat exchangers 105-108 and storage tanks 109 and 111. The person skilled in the art will readily understand that further elements may be present if desired.

During use of the embodiment shown in FIG. 2, the bottom stream 100,100a is (after expansion in Joule-Thomson valve 16) separated in the fourth gas/liquid separator 101 thereby obtaining at least a gaseous overhead stream 120 and a liquid bottom stream 130. The liquid bottom stream 130 removed from the fourth gas/liquid separator 101 is (after expansion in Joule-Thomson valve 17) separated in fifth gas/liquid separator 102 thereby obtaining at least a gaseous overhead stream 140 and a liquid bottom stream 150. The stream 150 may be subjected to one or more further fractionation steps in the fractionation unit 15 to collect various natural gas liquid products.

If desired, and as shown in FIG. 2, gaseous stream 120 obtained from the fourth gas/liquid separator 101 is cooled against the LNG stream 110 thereby obtaining cooled stream 160. This cooled stream 160 is then preferably split in splitter 103 into at least two streams 160a,160b. Stream 160a may then be recycled to the fourth gas/liquid separator 101 and a stream 160b may be further cooled by indirect heat exchange against the liquid hydrocarbon stream 110 to be vaporized. This further cooled stream may then be liquefied and sent as stream 160c (preferably liquefied propane) to the storage tank 109.

Similarly, gaseous stream 140 obtained form the fifth gas/liquid separator 102 may be cooled against the LNG stream 110 thereby obtaining cooled stream 170. This cooled stream 170 is then preferably split in splitter 104 into at least two streams 170a,170b. Stream 170a may then be recycled to the fifth gas/liquid separator 102 and stream 170b may be further cooled by indirect heat exchange against the liquid hydrocarbon stream 110 to be vaporized. This further cooled stream may then be liquefied and sent as stream 170c (preferably liquefied butane) to the storage tank 111.

The splitters 103 and 104 will usually be conventional splitters thereby obtaining at least two streams having the same composition. However, if desired, also gas/liquid separators may be used instead to obtain at least the steams 160a, 160b and 170a, 170b.

An advantage of the use of the available cold of the LNG stream 110 in the fractionating section comprising the fourth and fifth gas/liquid separators 101 and 102, these separators 101, 102 can be operated at lower pressure, which results in lower CAPEX.

The person skilled in the art will understand that many flow schemes may be designed for the LNG stream 110 in connection with the line-up of FIG. 2 in order to have it fully vaporized. FIG. 3 shows a preferred flow scheme of the LNG stream as used in FIG. 2.

As is shown in FIG. 3, the liquid hydrocarbon stream 110 to be vaporized is heat exchanged (in heat exchanger 8) against the gaseous stream 60 removed from the second gas/liquid separator 3 before it is heat exchanged (in heat exchangers 105,107) against one or more of the gaseous streams 120,140 removed from the fourth and fifth gas/liquid separators 101,102.

More specifically, LNG stream 110 is first split into at least two sub-streams wherein the first sub-stream 110a is heat exchanged in heat exchangers 8,5,105, whilst the second sub-stream 110A of stream 110 is heat exchanged in heat exchangers 106,108. Then (at least some of) the sub-streams are recombined (as stream 110X) and heat exchanged in heat exchanger 107 thereby obtaining vaporized stream 110Y.

Table I gives an overview of the estimated pressures and temperatures of the streams at various parts in an example process of FIG. 2, using the LNG flow scheme of FIG. 3. The hydrocarbon feed stream in line 10 of FIG. 1 comprised approximately the following composition: 80 mole % methane, 9.5 mole % ethane, 5.5 mole % propane, 3 mole % butanes and pentane and 2 mole % N₂. Other components such as CO₂, H₂S and H₂O were previously removed.

The person skilled in the art will readily understand that many modifications may be made without departing from the scope of the invention. As an example, the compressors may comprise two or more compression stages. Further, each heat exchanger may comprise a train of heat exchangers.

TABLE I

| | | Temperature | Phase |
|---|---|---|---|
| Line | Pressure (bar) | (° C.) | composition* |
| 10 | 35.9 | −24.6 | V/L |
| 20 | 35.8 | −24.0 | V |
| 30 | 35.8 | −24.0 | L |
| 40 | 33.7 | −24.8 | V/L |
| 50 | 33.7 | −25.5 | V/L |
| 60 | 33.5 | −42.0 | V |
| 70 | 33.2 | −63.0 | V/L |
| 80 | 33.1 | −63.1 | L |
| 90 | 33.1 | −63.1 | V |
| 100 | 33.7 | 107.5 | L |
| 120 | 6.7 | 10.9 | V |
| 130 | 6.9 | 66.4 | L |
| 140 | 3.2 | 26.3 | V |
| 150 | 3.4 | 84.0 | L |
| 160/160^{a}/160b | 6.7 | 10.9 | L |
| 160c | 1.0 | −42.8 | L |
| 170/170^{a}/170b | 3.2 | 26.4 | L |
| 170c | 1.0 | −7.7 | L |
| 110/110^{a}/110A | 85.0 | −155.0 | L |
| 110b | 84.2 | −69.0 | L |
| 110c | 83.3 | −17.0 | V |
| 110d | 82.5 | 11.0 | V |
| 110B | 84.2 | −48.0 | V |
| 110C | 83.3 | −12.0 | V |
| 110X | 83.3 | −17.0 | V |
| 110Y | 82.5 | 21.0 | V |

*V = vapour, L = Liquid

1. Method of heating a liquid hydrocarbon stream to be vaporized, the method at least comprising the steps of:
(a) supplying a partly condensed hydrocarbon feed stream to a first gas/liquid separator;
(b) separating the hydrocarbon feed stream in the first gas/liquid separator into a gaseous stream and a liquid stream;
(c) expanding the liquid stream obtained in step (b) and feeding it into a second gas/liquid separator at a first feeding point;
(d) expanding the gaseous stream obtained in step (b), thereby obtaining an at least partially condensed stream, and subsequently feeding it into the second gas/liquid separator at a second feeding point;
(e) removing from the second gas/liquid separator a gaseous stream, partially condensing it and feeding it into a third gas/liquid separator;
(f) separating the stream fed in the third gas/liquid separator in step (e) thereby obtaining a liquid stream and a gaseous stream;
(g) feeding the liquid stream obtained in step (f) into the second gas/liquid separator at a third feeding point; and
(h) removing from the second gas/liquid separator a liquid stream;
wherein the gaseous stream removed from the second gas/liquid separator in step (e) is partially condensed by heat exchanging against the liquid hydrocarbon stream to be vaporized and wherein the liquid hydrocarbon stream to be vaporized is in the dense phase.

2. Method according to claim 1, further comprising:
(i) feeding the liquid stream removed from the second gas/liquid separator to a fourth gas/liquid separator thereby obtaining a liquid stream and a gaseous stream.

3. Method according to claim 2, further comprising:
(j) feeding the liquid stream obtained from the fourth gas/liquid separator to a fifth gas/liquid separator thereby obtaining a liquid stream and a gaseous stream.

4. Method according to claim 2, further comprising:
(k) cooling the gaseous stream obtained in step (i) by heat exchange against the liquid hydrocarbon stream to be vaporized.

5. Method according to claim 4, wherein the cooled stream is split into at least two streams, a first stream being recycled to the fourth gas/liquid separator and a second stream being further cooled by heat exchange against the liquid hydrocarbon stream to be vaporized.

6. Method according to claim 3, further comprising:
(l) cooling the gaseous stream obtained in step (j) by heat exchange against the liquid hydrocarbon stream to be vaporized.

7. Method according to claim 6, wherein the cooled stream is split into at least two streams, a first stream being recycled to the fifth gas/liquid separator and a second stream being further cooled by heat exchange against the liquid hydrocarbon stream to be vaporized.

8. Method according to claim 1, wherein the partially condensed hydrocarbon feed stream has been previously cooled against the liquid hydrocarbon stream to be vaporized.

9. Method according to claim 1, wherein the gaseous stream obtained in step (f) is sent to a gas network.

10. Method according to claim 9, wherein the heated liquid hydrocarbon stream to be vaporized is sent to a gas network.

11. Method according to claim 1, wherein the liquid hydrocarbon stream to be vaporized has a pressure of at least 70 bar.

12. Method according to claim 11, wherein the liquid hydrocarbon stream to be vaporized has a pressure of below 100 bar.

13. Method according to claim 4, wherein the liquid hydrocarbon stream to be vaporized is heat exchanged against the gaseous stream removed from the second gas/liquid separator before it is heat exchanged against one or more of the gaseous streams removed from the fourth and fifth gas/liquid separators.

14. Method according to claim 1, comprising at least partially vaporizing the liquid hydrocarbon stream, wherein at least partially vaporizing the liquid hydrocarbon stream comprises said heat exchanging against the gaseous stream removed from the second gas/liquid separator in step (e).

15. Apparatus for heating of a liquid hydrocarbon stream to be vaporized, the apparatus at least comprising:
a first gas/liquid separator having an inlet for a partly condensed hydrocarbon feed stream, a first outlet for a gaseous stream and a second outlet for a liquid stream;
a second gas/liquid separator having at least a first outlet for a gaseous stream and a second outlet for a liquid stream and first, second and third feeding points;
a third gas/liquid separator having an inlet for the stream obtained at the first outlet of the second gas/liquid separator, a first outlet for a gaseous stream and a second outlet for a liquid stream, the second outlet being connected to the third feeding point of the second gas/liquid separator;
a first expander connected to the first outlet of the first gas/liquid separator and comprising a first expander outlet connected to the second feeding point of the second gas/liquid separator;
a second expander connected to the second outlet of the first gas/liquid separator and comprising a second expander outlet connected to the first feeding point of the second gas/liquid separator;
a first heat exchanger between the first outlet of the second gas/liquid separator and the inlet of the third gas/liquid separator; and
wherein the first heat exchanger is arranged to receive the liquid hydrocarbon stream to be vaporized in dense phase and to receive heat from the gaseous stream obtained from the first outlet of the second gas/liquid separator.

16. Method according to claim 3, further comprising:
(k) cooling the gaseous stream obtained in step (i) by heat exchange against the liquid hydrocarbon stream to be vaporized.

17. Method according to claim 16, wherein the cooled stream is split into at least two streams, a first stream being recycled to the fourth gas/liquid separator and a second stream being further cooled by heat exchange against the liquid hydrocarbon stream to be vaporized.

18. Method according to claim 4, further comprising:
(l) cooling the gaseous stream obtained in step (j) by heat exchange against the liquid hydrocarbon stream to be vaporized.

19. Method according to claim 16, further comprising:
(l) cooling the gaseous stream obtained in step (j) by heat exchange against the liquid hydrocarbon stream to be vaporized.

20. Method according to claim 5, further comprising:
(l) cooling the gaseous stream obtained in step (j) by heat exchange against the liquid hydrocarbon stream to be vaporized.
